(19) United States
(12) Patent Application Publication
(10) Pub. No.: US 2008/0118605 A1
(43) Pub. Date: May 22, 2008

(54) NOVEL ENHANCED BAKING STAMP

(76) Inventor: Nanette Theresa Owen, Lake Forest, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/943,853

(22) Filed: Nov. 21, 2007

Related U.S. Application Data
(60) Provisional application No. 60/860,617, filed on Nov. 22, 2006.

(51) Int. Cl. A21C 11/08; A21C 13/00

(52) U.S. Cl. 426/87; 101/405; 264/219; 425/406; 426/104; 426/302; 426/306; 426/383

(57) ABSTRACT

A novel baking stamp imprints designs comprising alphanumeric symbols or graphics into baked goods. Recesses in the novel baking stamp allow the alphanumeric symbols and graphics to be clearly shown in baked goods.

### RELATED APPLICATION

This application and all invention herein claims the full Paris Conversion priority benefit of U.S. Provisional Application Ser. No. 60/860,617, filed Nov. 22, 2006, the contents of which are incorporated by reference herein in its entirety.

### BACKGROUND

Baking stamps have been used to create shapes by putting finishings on to baked goods. Baking stamps, however, typically imprint shallowly, which causes the designs imprinted into the baked goods to be difficult to identify after baking. The present disclosure provides apparatuses and methods for improving the clarity of the designs imprinted into baked goods.

### SUMMARY

A novel baking stamp imprints designs comprising alphanumeric symbols or graphics into baked goods. Recesses in the novel baking stamp allow the alphanumeric symbols and graphics to be clearly shown in the baked goods.

According to a feature of the present disclosure, an apparatus is disclosed which comprises, an imprinter, the imprinter having grooves to imprint a baked good with alphanumeric symbols or graphics that are clear after baking; and a device for the exertion of pressure on the apparatus orthogonal to a surface having the imprinter.

According to embodiments, the apparatus comprises an imprinter with grooves to imprint a baked good with a string of characters selected from a group consisting of alphanumeric symbols, graphical representations, and hieroglyphics that are clear after baking. Pressure is then exerted on the apparatus orthogonal to a surface having the imprinter.

According to further embodiments, the method provides an imprinting device to imprint baked goods with a string of characters selected from a group of alphanumeric symbols, other types of representative symbols, or graphical images which then causes an imprint on baked goods.

Therefore, the process of providing a finishing baked good comprising, in combination, impacting a surface of the baked good with an imprinting surface to impact a pattern.

The apparatus is comprised of a kit with an imprinting tool for baked goods consisting of a disk having a first and second surface. The front disk is aligned with a second disk with a handle device attached thereto, whereby the first surface of said front disk remains unobstructed and attaches the two disks.

Similarly disclosed according to a feature of the present disclosure is a method comprising: providing an imprinting device to imprint baked goods with alphanumeric symbols or graphics; and causing an entity to use the imprinting device to imprint baked goods.

### DRAWINGS

The above-mentioned features and objects of the present disclosure will become more apparent with reference to the following description taken in conjunction with the accompanying drawings wherein like reference numerals denote like elements and in which:

FIG. 1 is an exploded view of an embodiment of a baking stamp of the present disclosure;

FIG. 2 is a side view of an embodiment of a front disk of a baking stamp of the present disclosure;

FIG. 3 is a front view of an embodiment of a front disk of a baking stamp of the present disclosure;

FIG. 4 is a side view of an embodiment of a back disk of a baking stamp of the present disclosure;

FIG. 5 is a top view of an embodiment of a back disk of a baking stamp of the present disclosure; and

FIG. 6 is side view of an embodiment of a baking stamp of the present disclosure.

### DETAILED DESCRIPTION

The present disclosure relates to a novel baking stamp to produce baked goods with at least one string of characters selected from the group consisting of graphics and alphanumeric symbols (collectively “designs”) on a surface of the baked goods. In particular, the present disclosure is useful when used as a cookie stamp. The device of the present disclosure provides a superior imprinting apparatus by providing precise designs on baked goods. Likewise, the present invention functions actively as part of larger wheels or motorized mechanized assembling mechanism.

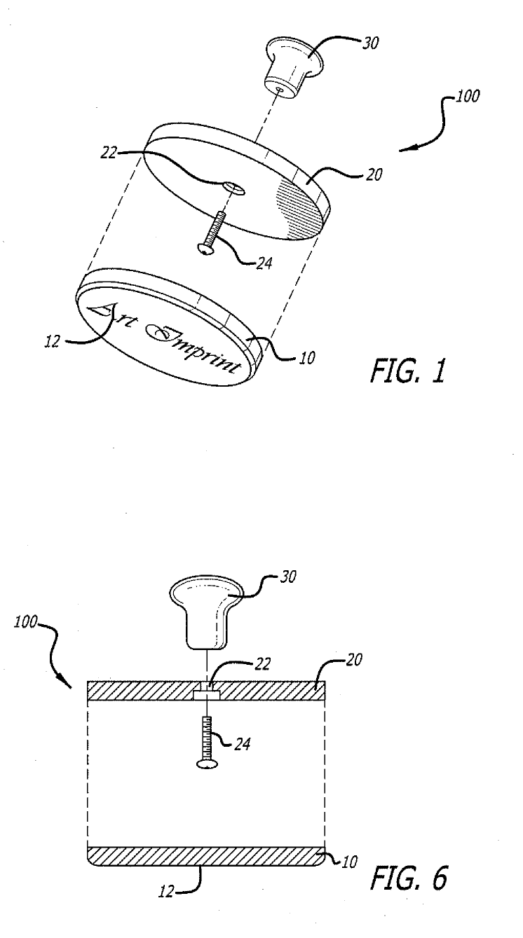

According to an embodiment shown in FIG. 1, baking stamp device 100 of the present disclosure is shown. As shown in FIG. 1, baking stamp device 100 comprises front disk 10, back disk 20, and pressure exertion device 30. The components are affixed together, as known to artisans, and together may be used to imprint baked goods.

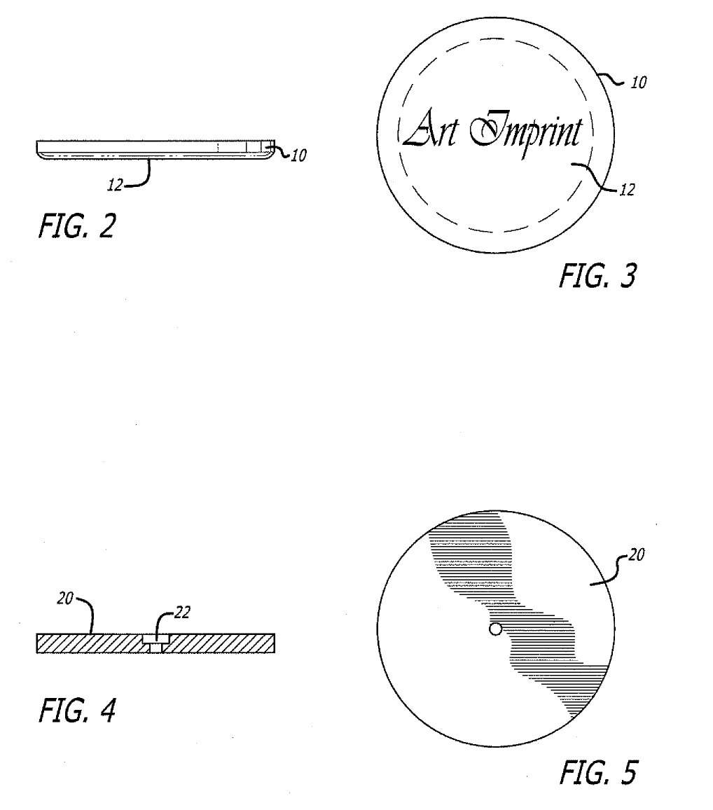

Front disk 10 may be made from materials in which imprinter 12 may be formed, such as acrylic. Imprinter 12 comprises an outward surface of front disk 10. As shown in an embodiment of FIG. 2, front disk 10 comprises two substantially flat surface and at least one side. According to embodiments, one or both substantially flat surfaces may be beveled. Imprinter is formed by recesses and non-recessed surfaces of the outward surface of front disk 10. The combination of the recesses and non-recessed surfaces provide contrast for a variety of designs. According to embodiments, variations in the depth of the recesses may be used to provide further contrast.

According to embodiments, laser etching is used to create imprinter 12 of front disk 10. Molding, carving, acid etching, and other similar methods of creating imprinter 12 are also contemplated and within the scope of the present disclosure. A person of ordinary skill in the art will know and understand how to form imprinter 12 in the exterior surface of front disk 10. According to embodiments and as shown in FIG. 3, imprinter 12 may comprise substantially all of the surface area of the outward surface of front disk 10, reserving a small margin.

According to embodiments, front disk is made from white acrylic. The white acrylic simplifies the process of etching imprinter 12, machining front disk 10, and improves appearance.

Turning again to FIG. 1 and according to embodiments, back disk 20 provides the anchoring for pressure exertion device 30. Back disk may be made from the same or different materials as front disk 10, as would be understood by artisans. Pressure exertion device 30 is affixed to back disk 20 via connector 24. Connector may be a screw, nail, brad, post, or other device that fastens pressure exertion device 30 to back disk 20. Pressure exertion device 30 will be applied so as to allow pressure to be exerted on baking stamp 100 orthogonal to the surface having imprinter 12. According to embodiments, a plurality of pressure exertion devices 30 may be affixed to baking stamp 100.

According to embodiments, pressure exertion device 30 may simply be glued to back disk 20 with an appropriate adhesive, such as epoxy. Where pressure exertion device 30 is affixed to back disk 20 by an adhesive, front disk 10 and back disk 20 may be the same component, with imprinter 12 on one surface and pressure exertion device 30 on another surface, such that the functionality described herein is maintained. Artisans will appreciate the methods by which pressure exertion device 30 may be affixed to back disk 20.

According to embodiments and as shown in FIG. 4, back disk 20 may have countersink 22. Countersink 22 provides a recess for head of connector 24, if present. For example, if connector 24 is a screw, then the head of the screw will fit into countersink 22 so that the inward surfaces of front disk 10 and back disk 20 may articulate along substantially the entire inward surface of at least one (in the event one of front disk 10 or back disk 20 is has a larger surface area than the other), but generally both, front disk 10 and back disk 20.

As shown in FIG. 5, The outward surface of back disk 20 comprises an opening in which connector 24 may pass through to articulate with pressure exertion device 30. Connector 24 may be used alone, or in combination with an adhesive, according to embodiments. According to other embodiments, a plurality of connectors 24 may be used.

FIG. 6 shows an embodiment of the assembly of baking stamp 100. Imprinter 12 is affixed or created prior to assembly of baking stamp 100, according to embodiments. Pressure exertion device 30 is first affixed to back disk 20 by a combination of connector 24 and adhesive. The head of connector 24 recesses into countersink 22. After pressure exertion device 30 is affixed to back disk 20, front disk 10 and back disk 20 are connected with an adhesive, such as an acrylic sheet cement. According to the embodiment shown in FIG. 6, the beveled surface of front disk 10 is the outward surface of front disk 10. Artisans will know and understand the many variations in which the components of baking stamp 100 maybe assembled to retain the functionality of baking stamp 100 as disclosed herein.

After baking stamp 100 is assembled, imprinter may need to be polished, that is, have burrs and other imperfections addressed prior to use. Burrs, rough edges, and other imperfections may be removed by using jewelers tools, according to embodiments. For example, dremel-type rotor tools with aluminum oxide, silicon carbide, or tungsten carbide tips may be used in the grooves of each design to address burrs, rough edges, and other imperfections.

According to embodiments, baking stamp 100 is used on raw baking dough. A ball of dough is prepared. Once the ball is formed, baking stamp 100 is applied to the dough. Application of baking stamp 100 flattens the dough and leaves the imprint of the design in the dough. Thereafter the dough is cooked, as would be known and understood by artisans. According to other embodiments, baking stamp 100 is used after the baked good is baked.

According to embodiments, a ring may be used during the imprinting process. Dough is place inside the ring prior to being imprinted with baking stamp 100. Use of a cookie-cutter type ring prevents the dough ball from flattening completely as a result of the pressure applied by baking stamp 100. Moreover, by limiting the amount of flattening permissible by the dough ball, imprinter 12 is able to more clearly imprint the design into the dough.

According to embodiments, bevels on the exterior surface of front disk 10 allow baking stamp 100 to be removed more cleanly. By rocking baking stamp 100 back and forth, the bevel prevents significant indentation of the dough, while at the same time loosening the dough from imprinter 12 and baking stamp 100.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

While the method and agent have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. An apparatus comprising:
an imprinter, the imprinter having grooves to imprint a baked good with at least a string of characters selected from the group consisting of alphanumeric symbols, graphical representations, and hieroglyphics that are clear after baking;
a pressure exertion device for the exertion of pressure on the apparatus orthogonal to a surface having the imprinter.

2. The apparatus of claim 1, wherein the baked good comprises at least one of an unbaked dough, an unprocessed dough and related.

3. The apparatus of claim 1, wherein the baked good is prebaked.

4. The apparatus of claims 2 or 3, wherein the imprinter comprises a front disk, a back disk, wherein the imprinter resides on an exterior surface of the front disk, and wherein the pressure exertion device resides on the back disk.

5. The apparatus of claim 4, wherein the front disk is connected to the back disk with glue.

6. The apparatus of claim 4 or 5, wherein the imprinter comprises recesses in the front disk.

7. A method comprising:
providing an imprinting device to imprint baked goods with at least a string of characters selected from the group of alphanumeric symbols, other types of representative symbols, and graphical images;
causing an entity to use the imprinting device to imprint baked goods.

8. The method of claim 7, further comprising at least a step selected from group of dipping and coating with additional agents.

9. The method of claim 8, the additional agent is at least one confectionary selected from the group consisting essentially of chocolate, cinnamon, and other sweetening agents effective for forming a layer upon at least part of the baked goods.

10. A processing for finishing baked goods which comprises, in combination; impacting a surface of at least a baked good with at least an imprinting surface to impact a pattern.

11. Products, by the process of claim 10.

12. Products, according to claim 10 and instructions for using them.

13. A kit, according to claim 12.

14. A process for making an imprinting tool for baked goods comprising:
providing at least a front disk having a first and second surface;
aligning the front disk with a second disk, having a handle device attachable thereto, whereby a first surface of said front disk remains unobstructed;
attaching the two disks.

15. The process of claim 14, the at least a front disk being cast acrylic.

16. The process of claim 15, said at least a front disk having art imprinted etchings dispersed there upon.

17. A product, the by process of claim 16, wherein said etching are done by a laser.
